(19) United States
(12) Patent Application Publication
(10) Pub. No.: US 2005/0144930 A1
(43) Pub. Date: Jul. 7, 2005

(54) Gas explosion machine

(76) Inventor: Shu-Heng Sun, Taipei (TW)

Correspondence Address: SHU-HENG SUN, 235 Chung - Ho, Box 8-24, Taipei, TW

(21) Appl. No.: 10/751,066

(22) Filed: Jan. 5, 2004

(51) Int. Cl. F02G 1/00

(52) U.S. Cl. 60/39.55

(57) ABSTRACT

An air explosive machine comprises a cambered front surface, a tapered rear surface, an air nozzle at a distal end of the rear surface and having a reduced opening; a check valve pivotally installed on the air nozzle; the front surface of the air explosive machine being formed with a plurality of oil injecting holes and a plurality of moisture injecting holes for being connected with fuel moisturizing devices and moisture input devices. The pushing force from the air explosive machine is very great so as to effectively actuate a machine. In the present invention, the fuel and air are mixed and explode. The combustion is completely and no waste air generates. The thermal energy generated from the explosion is stored in the explosive air storage tank. No energy lose occurs since no tube is used to transfer the energy.

### FIELD OF THE INVENTION

The present invention relates to gas explosion machines, and particular to a gas explosion machine, wherein fuel and air are mixed and explode completely. The combustion is completely and no waste air generates. The thermal energy generated from the explosion is stored in the explosive air storage tank. No energy lose occurs since no tube is used to transfer the energy.

### BACKGROUND OF THE INVENTION

Steam machine is widely used conventionally as a power source for generating power. Most of the plants, such as nuclear power plants, use steam machines as power source. However, this prior art way needs a larger area to built a power plant and then electric power is transferred through a long transfer path. Thereby, the power lose in the transmission is large, thus power efficiency is low. Since a power plant needs a larger area and thus it is built far from those places using the power. This also induces some inconveniency to human people. Thereby, there is an eager demand for a novel design which can improve the prior art defect.

### SUMMARY OF THE INVENTION

Accordingly, the primary object of the present invention is to provide an air explosive machine which comprises a cambered front surface, a tapered rear surface, an air nozzle at a distal end of the rear surface and having a reduced opening; a check valve pivotally installed on the air nozzle; the front surface of the air explosive machine being formed with a plurality of oil injecting holes and a plurality of moisture injecting holes for being connected with fuel moisturizing devices and moisture input devices. The pushing force from the air explosive machine is very great so as to effectively actuate a machine. In the present invention, the fuel and air are mixed and explode. The combustion is completely and no waste air generates. The thermal energy generated from the explosion is stored in the explosive air storage tank. No energy lose occurs since no tube is used to transfer the energy.

The various objects and advantages of the present invention will be more readily understood from the following detailed description when read in conjunction with the appended drawing.

### BRIEF DESCRIPTION OF THE DRAWINGS

FIG. 1 is a schematic view of the present invention.

FIG. 2 is a schematic view about the arrangement of the front surface of the present invention.

FIG. 3 is a schematic view about the oil tube of the present invention.

FIG. 4 is a schematic view about one embodiment of the present invention.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

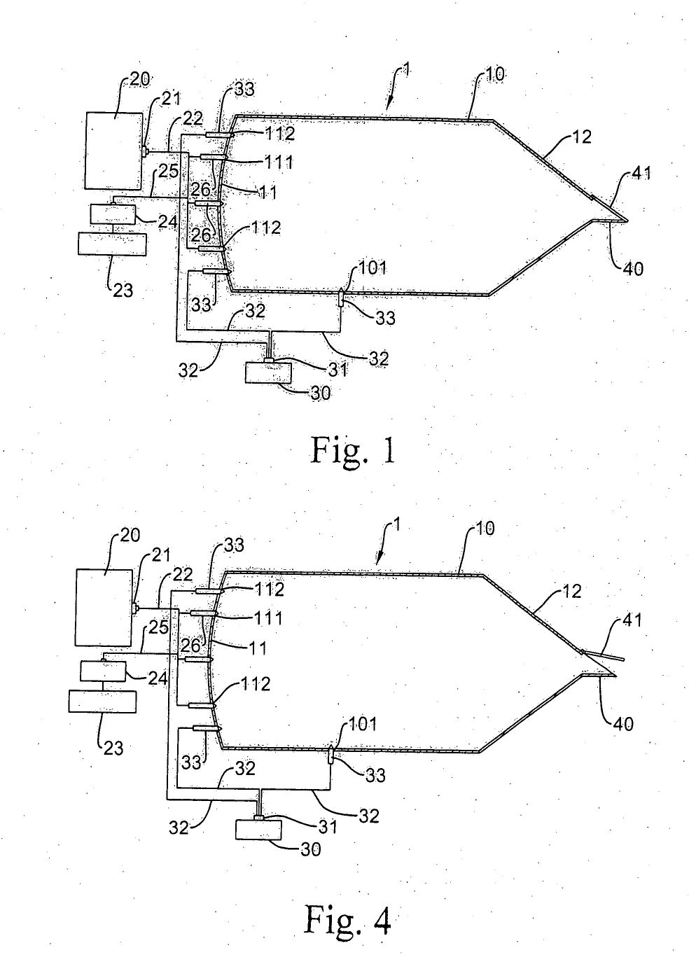

With reference to FIG. 1, the air explosive machine 1 of the present invention is illustrated. The air explosive machine 1 includes a cambered front surface 11, a tapered rear surface 12, an air nozzle 40 at a distal end of the rear surface 12 and having a reduced opening; a check valve 41 pivotally installed on the air nozzle 40. The front surface 11 of the air explosive machine 1 is formed with a plurality of oil injecting holes 111 and a plurality of moisture injecting holes 112b for being connected with fuel moisturizing devices and moisture input devices.

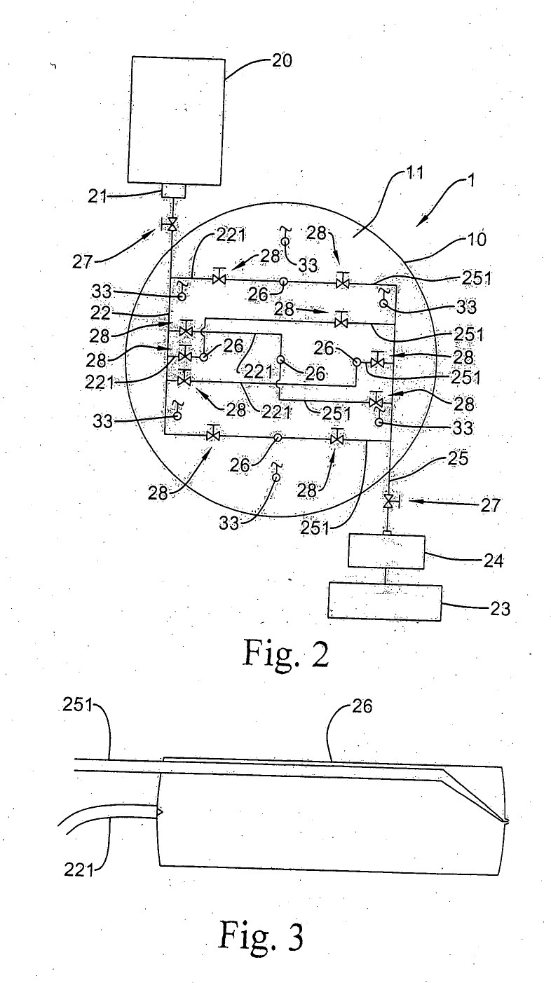

With reference to FIGS. 1 and 2, in the fuel moisturizing machine, the oil injecting hole 111 is installed with a fuel gasifying tube 26. Each fuel gasifying tube 26 is connected to a stub tube 221. A distal end of each stub tube 221 is connected to an oil tube 22. The oil tube 22 is installed with a main switch 27 for fully controlling the opening and closing of the stub tube 221. Each stub tube 221 is installed with a switch 28 for controlling the flow rate of the fuel gasifying tube 26 by closing or opening of the fuel gasifying tube 26. A front end of each oil tube 22 is connected to an oil pump 21 and an oil tank 20. When the oil pump 21 is actuated, the fuel in the oil tank 20 is pumped out. The oil flows through the oil tube 22 and the stub tube 221 to the fuel gasifying tube 26.

Referring to FIGS. 2 and 3, each fuel gasifying tube 26 is connected to a stub tube 251. A distal end of each stub tube 251 is connected to a air tube 25. A main switch 28 is installed in the stub tube 251. The air flow rate for the air flowing into the fuel gasifying tube 26 is controllable by the opening and closing the switch 28. An air box 24 is installed at a front end of the air tube 25. An air compressor 23 serves to supply air into the air box 24 for moisturizing liquid fuel. Then the moisture is injected into the explosive air storage tank 10.

In the moisture input devices, a plurality of moisture injecting holes 112 in a front surface 11 of the explosive air storage tank 10 and a plurality of moisture injecting holes 101 are formed in a lateral peripheral surface of the explosive air storage tank 10. Each of the moisture injecting hole 112, 101 is formed with a moisture nozzle 33. The water nozzle 33 is connected to the water pump 31 and the water box 30 through a transfer tube 32. When the water pump 31 is actuated, water in the water box 30 will inject water into the explosive air storage tank 10 through the transfer tube 32 and the moisture nozzle 33.

The use of the explosive air storage tank 10 is to replace the current used boiler of a steam machine. An igniter is installed in the explosive air storage tank 10. The liquid fuel outputted from the oil tank 20 is mixed with air in the air box 24 and then the mixture is injected the explosive air storage tank 10, which is then exploded by the igniter.

Referring to FIG. 4, one embodiment of the present invention is illustrated. The explosive air storage tank 10 is like an air box in the steam machine. When explosion occurs in the explosive air storage tank 10, a great thermal energy generates from the explosion of the fuel. Then water pump 31 starts, the water in the water box 30 is moisturized by the water nozzles 33. Thereby, the exploded fire in the water pump 31 is injected by the moisture so as to generate steam. Other than reducing the temperature of the fire, this method causes that the expansion force of air is increased so as to increase pressure, and pushing force. This large energy can be used to open a valve 41 so as to actuate a machine behind the air explosive machine 1. For example, the push force from the air explosion can be used to push, for example, a pulley behind the air explosive machine 1 to rotate. Moreover, the pushing force generated by the present invention can be used to control the flow rate of the main switch 27 and the switch 28 so as to further control the oil input and moisture rate flowing into the explosive air storage tank 10.

Therefore, by above said structure and operation, the present invention has the following advantages.

The pushing force from the air explosive machine is very great so as to effectively actuate a machine. In the present invention, the fuel and air are mixed and explode. The combustion is completely and no waste air generates. The thermal energy generated from the explosion is stored in the explosive air storage tank. No energy lose occurs since no tube is used to transfer the energy. However, in the prior art, the flame generated from a steam machine passes through a boiler in a short time period, but energy will be consumed at this stage. Thereby, the efficiency of the steam machine is low, but in the present invention, thermal energy is used completely. Thereby, air is used to assist the combustion and injection of moisture causes air to expansion. This also increases the thermal energy.

Furthermore, the heated air generated in the present invention can be used to push a machine, which is greatly over the steam. In the present invention, a plurality of oil injection openings can be opened or closed as desired without the danger of explosion. The size of the air explosive machine of the present invention can be designed as desired so as to achieve the object of saving thermal power. In the present invention, since all the thermal energy is used up, the fuel is used effectively. The air explosive machine of the present invention is integrally formed. The manufacturing cost is low and installation of the air explosive machine is easy. The plant for manufacturing the air explosive machine can be built easily with a lower cost and a small land. The location of the plant is not limited. Thereby, the power supplied system for the plant is also provided easily.

The present invention can be used after it is installed with less labors and cost. The cost of the electric power is low so as to provide cheap electric power. The air used in the present invention also has heat energy which can be used further.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. An air explosive machine comprising an outward cambered front surface, a tapered rear surface, an air nozzle at a distal end of the rear surface and having a reduced opening; a check valve pivotally installed on the air nozzle; the front surface of the air explosive machine being formed with a plurality of oil injecting holes and a plurality of moisture injecting holes for being connected with fuel moisturizing devices and moisture input devices.

2. The air explosive machine as claimed in claim 1, wherein for the fuel moisturizing device; the oil injecting hole in the front surface is installed with a fuel gasifying tube; each fuel gasifying tube is connected to a stub tube for being connected with an oil tube and an air tube; a front end of the oil tube is installed with an oil pump and an oil tank; a front end of the air tube is installed with an air box; and the air box is connected to an air compressor.

3. The air explosive machine as claimed in claim 2, wherein the oil tube is installed with a main switch and the air tube is installed with another main switch.

4. The air explosive machine as claimed in claim 2, wherein the stub tube is installed with a switch.

5. The air explosive machine as claimed in claim 1, wherein In the moisture input devices, a plurality of moisture injecting holes in a front surface of the explosive air storage tank and a plurality of moisture injecting holes is formed in a lateral peripheral surface of the explosive air storage tank; each of the moisture injecting hole is formed with a moisture nozzle; each water nozzle is connected to the water pump and the water box through a transfer tube.
